(19) United States
(12) Patent Application Publication
(10) Pub. No.: US 2015/0087464 A1
(43) Pub. Date: Mar. 26, 2015

(54) TWO MODE CONTINUOUSLY VARIABLE TRANSMISSION

(71) Applicant: GM Global Technology Operations LLC, Detroit, MI (US)

(72) Inventors: Edward W. Mellet, Rochester Hills, MI (US); James M. Hart, Belleville, MI (US)

(73) Assignee: GM Global Technology Operations LLC, Detroit, MI (US)

(21) Appl. No.: 14/486,109

(22) Filed: Sep. 15, 2014

Related U.S. Application Data
(60) Provisional application No. 61/881,078, filed on Sep. 23, 2013.

(51) Int. Cl. F16H 37/02; F16H 3/44; F16H 9/16

(52) U.S. Cl. CPC F16H 37/022; F16H 9/16; F16H 3/44; F16H 2200/2007; F16H 2200/2038
USPC 475/210

(57) ABSTRACT

A two mode CVT is provided for a motor vehicle. The CVT includes a speed change device connected to a pulley and belt assembly. The pulley and belt assembly is connected to a planetary gear set arrangement. The planetary gear set arrangement generally includes two planetary gear sets, one brake and two clutches. The planetary gear set arrangement is connected to a final drive unit.

### CROSS-REFERENCE TO RELATED APPLICATIONS

This application claims the benefit of U.S. Provisional Application No. 61/881,078 filed Sep. 23, 2013. The disclosure of the above application is incorporated herein by reference.

### FIELD

The present disclosure relates to automatic transmissions and more particularly to a two mode continuously variable transmission.

### BACKGROUND

The statements in this section merely provide background information related to the present disclosure and may or may not constitute prior art.

A continuously variable transmission (“CVT”) typically includes a belt and pulley system that operatively couples a rotary power source, such as an engine or electric motor, to a double gear final drive unit. The belt and pulley system generally includes first and second pairs of pulley cones having a torque transmitting belt or chain extending between the cone pairs. Each pulley cone pair includes an axially stationary pulley member and an axially movable pulley member. Each movable pulley member is axially adjustable with respect to the stationary pulley member by a hydraulic system. The hydraulic system provides primary and secondary hydraulic pressures to the respective movable pulley members to adjust the running radius of the first and second pulley cone pairs which in turn controls the output/input ratio of the continuously variable transmission. Movement of the cones steplessly or continuously varies the ratio of an input speed to an output speed. With the continuously variable transmission, small but effective ratio changes can be attained. This is in contrast to a fixed gear ratio unit where any ratio changes are step values.

CVT axial length and mass significantly impact its power density and efficiency. Accordingly, there is a constant need for improved CVT designs that minimize axial length and mass while providing sufficient performance characteristics.

### SUMMARY

A two mode CVT is provided that for a motor vehicle. The two mode CVT includes a speed change device connected to a pulley and belt assembly. The pulley and belt assembly is also connected to a planetary gear set arrangement. The planetary gear set arrangement generally includes two planetary gear sets, one brake and two clutches. The planetary gear set arrangement is connected to a final drive unit.

In another aspect of the present invention, a transmission for a motor vehicle is provided having a transmission input member, a transmission output member, a continuously variable unit, a first transfer gear, a second transfer gear, a planetary gear set assembly, a first clutch, a second clutch, a brake, whereby torque is transferred from the input member to the output member through selective engagement of one of the first clutch and the second clutch thereby selectively connecting the second pulley to the planetary gear set assembly.

In yet another aspect of the present invention, the continuously variable unit has a first pulley, a second pulley and an endless member wrapped around the first pulley and the second pulley.

In yet another aspect of the present invention, the first transfer gear is connected for common rotation with the input member.

In yet another aspect of the present invention, the second transfer gear is in mesh with the first transfer gear and connected for common rotation with the first pulley of the continuously variable unit.

In yet another aspect of the present invention, the planetary gear set assembly has first, second, third and fourth members.

In yet another aspect of the present invention, the first clutch selectively connects the second pulley to the first member of the planetary gear set assembly.

In yet another aspect of the present invention, the second clutch selectively connects the second pulley to the fourth member of the planetary gear set assembly.

In yet another aspect of the present invention, the brake selectively connects the third member of the planetary gear set assembly to a stationary member.

In still another aspect of the present invention, the planetary gear set assembly includes a first planetary gear set and a second planetary gear set. The first planetary gear set has a sun gear connected for common rotation to a sun gear of the second planetary gear set and a carrier member connected for common rotation to the ring gear of the second planetary gear set. The first clutch is connected to the ring gear of the first planetary gear set, the second clutch is connected to the sun gear of the first planetary gear set and the brake is connected to carrier member of the second planetary gear set and the output member is connected for common rotation to the ring gear of the second planetary gear set.

In still another aspect of the present invention, the planetary gear set assembly has a first planetary gear set and a second planetary gear set. The first planetary gear set has a carrier member connected for common rotation to a carrier member of the second planetary gear set and the carrier member of the second planetary gear set has a first and a second set of pinion gears. The first set of pinion gears intermesh with the sun gear of the first planetary gear set and the second set of pinions. The second set of pinions intermesh with the ring gear of the second planetary gear set and the first set of pinion gears. The first clutch is connected to the sun gear of the first planetary gear set, the second clutch is connected to the sun gear of the second planetary gear set and the brake is connected to carrier member of the first planetary gear set. The output member is connected for common rotation to the ring gear of the second planetary gear set.

In still another aspect of the present invention, the planetary gear set assembly includes a first planetary gear set and a second planetary gear set. The first planetary gear set has a carrier member connected for common rotation to a ring gear of the second planetary gear set and a ring gear of the first planetary gear set is connected for common rotation to a carrier member of the second planetary gear set. The first clutch is connected to the sun gear of the first planetary gear set, the second clutch is connected to the sun gear of the second planetary gear set and the brake is connected to carrier member of the first planetary gear set and ring gear of the second planetary gear set. The output member is connected for common rotation to the carrier member of the second planetary gear set.

In still another aspect of the present invention, the planetary gear set assembly has a first planetary gear set and a second planetary gear set in a stacked arrangement. The first planetary gear set and a second planetary gear set share a common member. The common member functions as a ring gear in the first planetary gear set and functions as a sun gear in the second planetary gear set. Additionally, the first planetary gear set and a second planetary gear set share a common carrier member having a first pinion gear that intermeshes with the sun gear of the first planetary gear set and the common member and a second pinion gear that intermeshes with the ring gear of the second planetary gear set and the common member. The first clutch is connected to the common member, the second clutch is connected to the sun gear of the first planetary gear set and the brake is connected to ring gear of the second planetary gear set. The output member is connected for common rotation with the common carrier member.

In still another aspect of the present invention, the planetary gear set assembly includes a first planetary gear set and a second planetary gear set. The first planetary gear set has a carrier member connected for common rotation to a carrier member of the second planetary gear set and a ring gear of the first planetary gear set is connected for common rotation to a ring gear of the second planetary gear set. The first clutch is connected to the ring gear of the first planetary gear set and ring gear of the second planetary gear set, the second clutch is connected to the sun gear of the first planetary gear set and the brake is connected to sun gear of the second planetary gear set. The output member is connected for common rotation to the carrier member of the first and second planetary gear sets.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and is not intended to limit the scope of the present disclosure in any way.

FIG. 1 is a schematic diagram of a powertrain according to the principles of the present invention;

FIG. 2 is a lever diagram of an exemplary transmission according to the principles of the present invention;

FIG. 3 is a diagrammatic illustration of another embodiment of a transmission according to the principles of the present invention;

FIG. 4 is a diagrammatic illustration of yet another embodiment of a transmission according to the principles of the present invention;

FIG. 5 is a diagrammatic illustration of still another embodiment of a transmission according to the principles of the present invention;

FIG. 6 is a diagrammatic illustration of still another embodiment of a transmission according to the principles of the present invention;

FIG. 7 is a diagrammatic illustration of still another embodiment of a transmission according to the principles of the present invention; and

FIG. 8 is a truth table presenting an example of a state of engagement of various torque transmitting elements to produce multiple forward and at least one reverse speed or gear ratios of the transmissions illustrated in FIGS. 1-7.

### DETAILED DESCRIPTION

The following description is merely exemplary in nature and is not intended to limit the present disclosure, application, or uses.

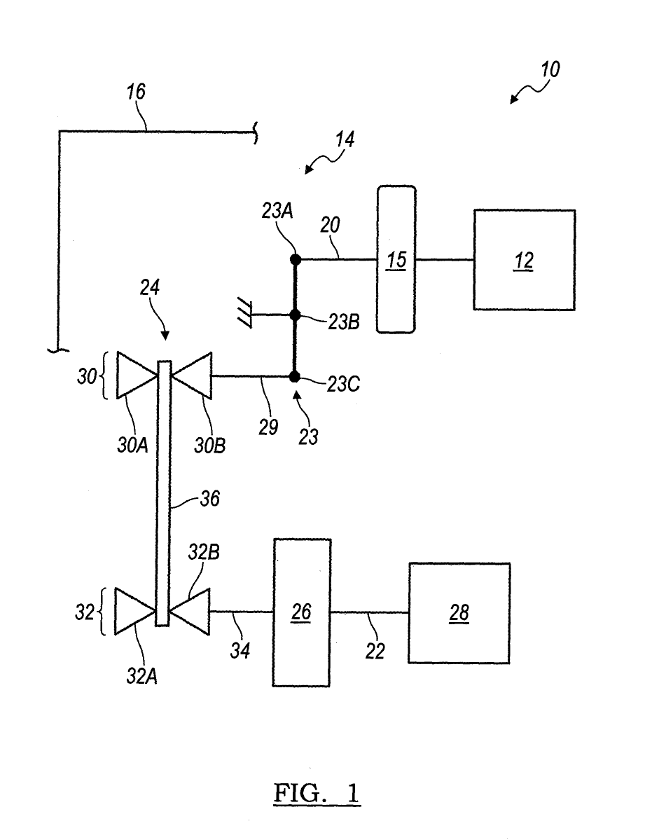

With reference to FIG. 1, a powertrain for a motor vehicle is generally indicated by reference number 10. The powertrain 10 generally includes an engine 12 interconnected with a transmission 14. The engine 12 may be a conventional gasoline, Diesel, or flex fuel internal combustion engine, a hybrid engine, or an electric motor, or any other type of prime mover, without departing from the scope of the present disclosure. The engine 12 supplies a driving torque to the transmission 14 through, for example, a flexplate (not shown) or other connecting device or a starting device 15 such as a hydrodynamic device or launch clutch.

The transmission 14 is a variable diameter pulley or sheave drive continuously variable transmission (CVT). The transmission 14 includes a typically cast, metal housing 16 which encloses and protects the various components of the transmission 14. The housing 16 includes a variety of apertures, passageways, shoulders and flanges which position and support these components. Generally speaking, the transmission 14 includes a transmission input shaft 20 and a transmission output shaft 22. Connected between the transmission input shaft 20 and the transmission output shaft 22 is a speed change device 23, a pulley assembly 24, and a gearbox 26 that cooperate to provide forward and reverse speed or gear ratios between the transmission input shaft 20 and the transmission output shaft 22. The transmission input shaft 20 is functionally interconnected with the engine 12 through the starting device 15 and receives input torque or power from the engine 12. The transmission output shaft 22 is preferably connected with a final drive unit 28. The transmission output shaft 22 provides drive torque to the final drive unit 28. The final drive 28 unit may include a differential, axle shafts, and road wheels (not shown).

The transmission input shaft 20 is connected to the speed change device 23. The speed change device 23, as well as the various gearbox 26 arrangements described below, are illustrated in a lever diagram format. A lever diagram is a schematic representation of the components of a mechanical device such as meshing gear sets or planetary gear sets. Each individual lever represents a planetary gear set or meshed gear pair. The three basic mechanical components of the planetary gear are each represented by a node while the gear pairs are represented by a node and the rotation change represented by a node fixed to ground. Therefore, a single lever contains three nodes. In a planetary gear set, one node represents the sun gear, one the planet gear carrier, and one the ring gear. In a meshed gear pair, one node represents a first gear, one a second gear, and the third the rotational direction change between the meshed gears. In some cases, two levers may be combined into a single lever having more than three nodes (typically four nodes). For example, if two nodes on two different levers are interconnected through a fixed connection they may be represented as a single node on a single lever. The relative length between the nodes of each lever can be used to represent the ring-to-sun ratio of each respective gear set. These lever ratios, in turn, are used to vary the gear ratios of the transmission in order to achieve an appropriate ratios and ratio progression. Mechanical couplings or interconnections between the nodes of the various planetary gear sets are illustrated by thin, horizontal lines and torque transmitting devices such as clutches and brakes are presented as interleaved fingers. Further explanation of the format, purpose and use of lever diagrams can be found in SAE Paper 810102, “The Lever Analogy: A New Tool in Transmission Analysis” by Benford and Leising which is hereby fully incorporated by reference.

For example, the speed change device 23 includes a first node 23A, a second node 23B, and a third node 23C. The first node 23A is coupled to the transmission input shaft 20. The second node 23B is fixed to ground representing a change in rotational direction. The third node 23C is coupled to a first transfer shaft or member 29 that is connected to the pulley assembly 24. The first node 23A preferably represents a first gear while the third node 23C preferably represents a second gear meshed with the first gear. The gears may be co-planar or partially axially offset. In a preferred embodiment, the speed change device 23 is an overdrive speed change device 23 that increases the speed of the first transfer shaft 29 relative to the transmission input shaft 20 while decreasing the torque. In a second preferred embodiment, the speed change device 23 is an underdrive speed change device 23. In a third preferred embodiment, the speed change device 23 acts as a direct drive coupling member with no relative speed change.

The pulley assembly 24 includes a first pulley or sheave pair 30 and a second pulley or sheave pair 32. The first pulley 30 includes a first truncated conical sheave or member 30A and second truncated conical sheave or member 30B in axial alignment with the first truncated conical sheave 30A. The second sheave 30B is directly connected for rotation with the first transfer member 29 and may be integrally formed with the first transfer member or shaft 29. The first sheave 30A is moveable axially relative to the second sheave 30B by a hydraulic control system (not shown) or other actuating system. It should be appreciated that the sheaves 30A and 30B may be axially switched without departing from the scope of the present invention.

The second pulley 32 includes a first truncated conical sheave or member 32A and second truncated conical sheave or member 32B in axial alignment with the first truncated conical sheave 32A. The second sheave 32B is directly connected for rotation with a second transfer shaft or member 34 or may be integrally formed with the second transfer shaft 34. The first sheave 32A is moveable axially relative to the second sheave 32B by a hydraulic control system (not shown) or other actuating system. It should be appreciated that the sheaves 32A and 32B may be axially switched without departing from the scope of the present invention.

A torque transmitting belt or chain 36 having a V-shaped cross section is mounted between the first pulley pair 30 and the second pulley pair 32. It should be appreciated that other types of belts, including positive engagement devices, may be employed without departing from the scope of the present invention. Drive torque communicated from the transmission input shaft 20 is transferred via friction between the sheaves 30A and 30B and the belt 36. The ratio of the input pulley 30 to the output pulley 32 is adjusted by varying the spacing between the sheaves 30A and 30B and between the sheaves 32A and 32B. For example, to change the ratio between the pulleys 30 and 32, the axial distance between sheaves 30A and 30B may be reduced by moving sheave 30A towards sheave 30B while simultaneously the axial distance between sheave 32A and 32B may be increased by moving sheave 32A away from sheave 32B. Due to the V-shaped cross section of the belt 36, the belt 36 rides higher on the first pulley 30 and lower on the second pulley 32. Therefore the effective diameters of the pulleys 30 and 32 change, which in turn changes the overall gear ratio between the first pulley 30 and the second pulley 32. Since the radial distance between the pulleys 30 and 32 and the length of the belt 36 is constant, the movement of the sheaves 30A and 32A must occur simultaneously in order to maintain the proper amount of tension on the belt 36 to assure torque is transferred from the pulleys 30, 32 to the belt 36.

The pulley assembly 24 transfers torque to the gearbox 26 via the second transfer shaft 34. The gearbox 26 comprises one of several planetary gear set transmissions or arrangements, as will be described in greater detail below. The gearbox 26 outputs torque from the pulley assembly 26 to the transmission output shaft 22 and then to the final drive unit 28.

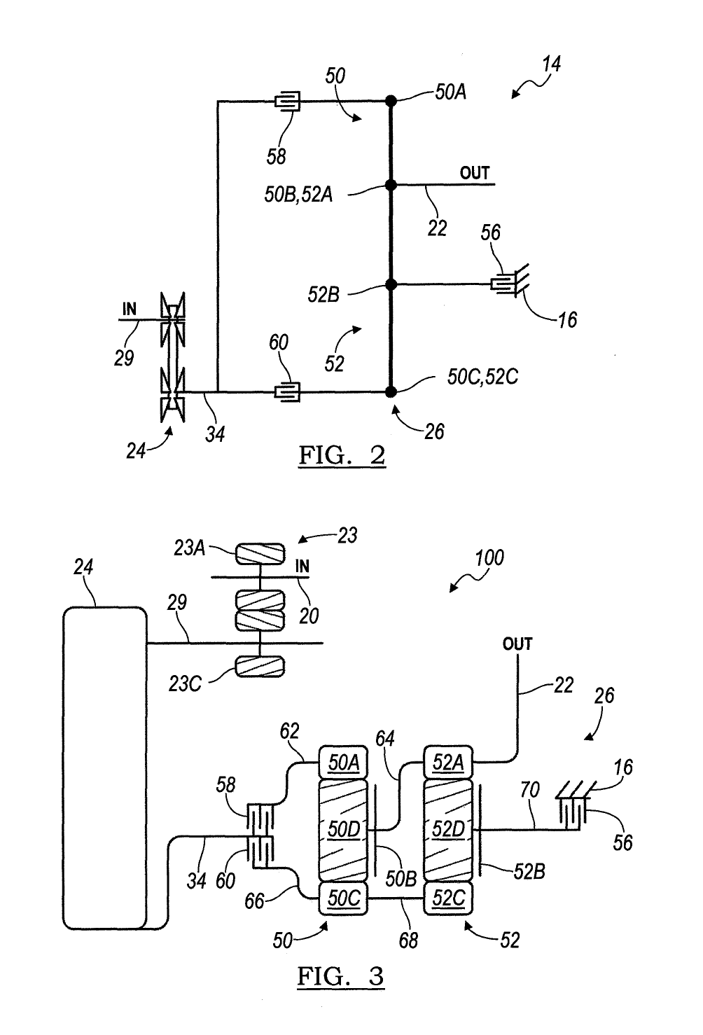

Turning now to FIG. 2, the planetary gear set transmissions or arrangements of gearbox 26 is shown in lever diagram format. The gearbox 26 includes a first planetary gear set 50 and a second planetary gear set 52. The first planetary gear set 50 has three nodes: a first node 50A, a second node 50B and a third node 50C. Each of the nodes represents a member of the planetary gear set, i.e.: a sun gear, a ring gear or a planet gear carrier. The second planetary gear set 52 has three nodes: a first node 52A, a second node 52B and a third node 52C. Nodes 50B and 52A have been combined into a single node 50B, 52A and nodes 50C and 52C have been combined into a single node 50C, 52C. The aforementioned nodes may be combined since a member (a sun gear, a ring gear or a planet gear carrier) of the first gear set 50 is continuously coupled or permanently connected with a member of the second planetary gear set 52.

The transmission output shaft or member 22 is continuously coupled to node 50B, 52A. A brake 56 selectively connects the node 52B of the second planetary gear set 52 with the stationary element or transmission housing 16. A first clutch 58 selectively connects the node 50A of the first planetary gear set 50 with the second transfer shaft 34. A second clutch 60 selectively connects the combined node 50C, 52C of the first and second planetary gear sets 50 and 52 with second transfer shaft 34.

Turning now to FIGS. 3-7 stick diagrams present schematic layouts of embodiments of the gearbox 26 according to the present invention. In FIGS. 3-7 the numbering from the lever diagram of FIG. 2 are carried over. The clutches and couplings are correspondingly presented whereas the nodes of the planetary gear sets now appear as components of planetary gear sets, such as, sun gears, ring gears, planet gears and planet gear carriers.

With specific reference to FIG. 3, a transmission 100 having an example of a gearbox 26 configuration is illustrated. Transmission 100, in accordance with the present invention, includes the speed change device 23 having a first gear 23A in mesh with a second gear 23C. Second gear 23C is rotatably coupled through first transfer member or shaft 29 to pulley assembly 24. Planetary gear set 50 includes a ring gear member 50A, a planet carrier member 50B and a sun gear member 50C. The ring gear member 50A is connected for common rotation with a first shaft or interconnecting member 62. The planet carrier member 50B is connected for common rotation with a second shaft or interconnecting member 64 and rotatably supports a set of planet gears 50D (only one of which is shown). The planet gears 50D are each configured to intermesh with the ring gear member 50A and the sun gear member 50C. The sun gear member 50C is connected for common rotation with a third shaft or interconnecting member 66 and a fourth shaft or interconnecting member 68.

Planetary gear set 52 includes a ring gear member 52A, a planet carrier member 52B and a sun gear member 52C. The ring gear member 52A is connected for common rotation with the second shaft or interconnecting member 64 and output member or shaft 22. The planet carrier member 52B is connected for common rotation with a fifth shaft or interconnecting member 70 and rotatably supports a set of planet gears 52D (only one of which is shown). The planet gears 52D are each configured to intermesh with the ring gear member 52A and the sun gear member 52C. The sun gear member 52C is connected for common rotation with the fourth shaft or interconnecting member 68.

Moreover, torque-transmitting mechanisms including brake 56 and clutches 58 and 60 are provided to allow for selective interconnection of the shafts or interconnecting members, members of the planetary gear sets and the housing. The torque-transmitting mechanisms are friction, dog or synchronizer type mechanisms or the like. For example, the brake 56 is selectively engageable to connect the fifth shaft or interconnecting member 70 with the transmission housing 16 in order to restrict relative rotation of the member 70 and therefore the carrier member 52B. The first clutch 58 is selectively engageable to connect the second transfer shaft 34 with the first shaft or interconnecting member 62 and the ring gear 50A. The second clutch 60 is selectively engageable to connect the second transfer shaft 34 with the third shaft or interconnecting member 66 and the sun gear 50C.

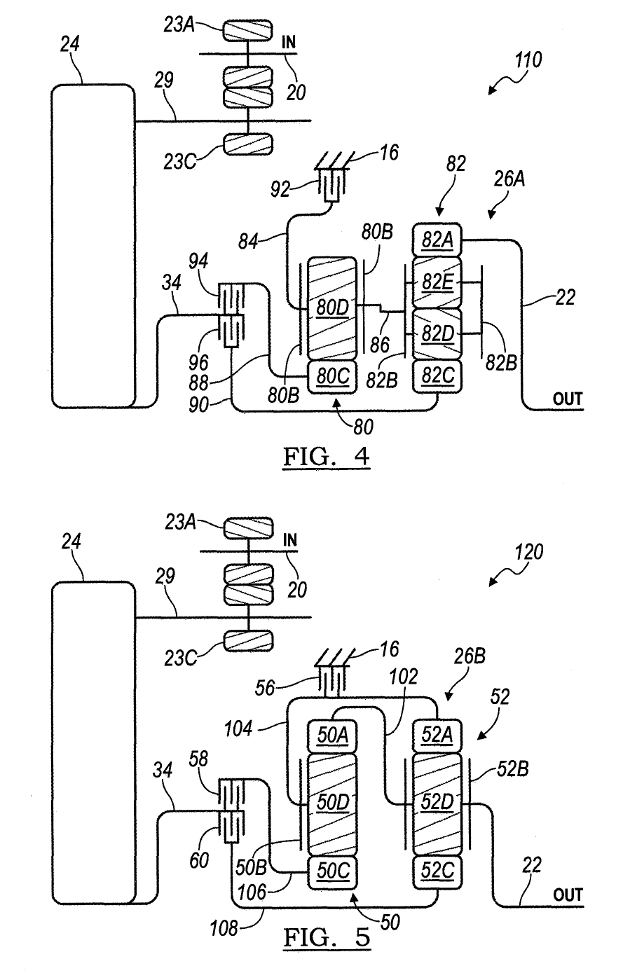

With specific reference to FIG. 4, a transmission 110 having an alternate gearbox 26A arrangement is illustrated. The transmission 110 is similar to transmission 100 shown in FIG. 3 and therefore like components are indicated by like reference numbers. Gearbox 26A includes a first planetary gear set 80 and a second planetary gear set 82.

Planetary gear set 80 includes a carrier member 80B and a sun gear 80C. The planet carrier member 80B is connected for common rotation with a first shaft or interconnecting member 84 and a second shaft or interconnecting member 86 and rotatably supports a set of planet gears 80D (only one of which is shown). The planet gears 80D are each configured to intermesh with the sun gear member 80C. The sun gear member 80C is connected for common rotation with a third shaft or interconnecting member 88.

Planetary gear set 82 includes a ring gear member 82A, a planet carrier member 82B and a sun gear member 82C. The ring gear member 82A is connected for common rotation with output member or shaft 22. The planet carrier member 82B is connected for common rotation with the second shaft or interconnecting member 86 and rotatably supports a first set of planet gears 82D (only one of which is shown) and a second set of planet gears 82E (only one of which is shown). The first set of planet gears 82D are each configured to intermesh with the sun gear member 82C and the second set of planet gears 82E. The second set of planet gears 82E are each configured to intermesh with the ring gear member 82A and the first set of planet gears 82D. The sun gear member 82C is connected for common rotation with the fourth shaft or interconnecting member 90.

Gearbox 26A further includes torque-transmitting mechanisms including brake 92 and clutches 94 and 96 are provided to allow for selective interconnection of the shafts or interconnecting members, members of the planetary gear sets and the housing. The brake 92 is selectively engageable to connect the first shaft or interconnecting member 84 with the transmission housing 16 in order to restrict relative rotation of the member 84 and therefore the carrier members 80B and 82B. The first clutch 94 is selectively engageable to connect the second transfer shaft 34 with the third shaft or interconnecting member 88 and the sun gear 80C. The second clutch 96 is selectively engageable to connect the second transfer shaft 34 with the fourth shaft or interconnecting member 90 and the sun gear 82C.

With specific reference to FIG. 5, a transmission 120 having an alternate gearbox 26B arrangement is illustrated. The transmission 120 is similar to transmission 100 shown in FIG. 3 and therefore like components are indicated by like reference numbers. Gearbox 26B includes the first planetary gear set 50 and a second planetary gear set 52, as described above. However, the interconnections to clutches 58 and 60 and brake 56 have been reconfigured, as described hereinafter. Ring gear 50A is now connected to a first interconnecting member 102. Carrier member 50B is now connected to a second interconnecting member 104. Sun gear 50C is now connected to a third interconnecting member 106. Moreover, ring gear 52A is now connected to the second interconnecting member 104. Carrier member 52B is now connected to the first interconnecting member 102. Sun gear 52C is now connected to a fourth interconnecting member 108. Accordingly, first clutch 58 is selectively engageable to connect the second transfer shaft 34 with the third shaft or interconnecting member 106 and the sun gear 50C. The second clutch 60 is selectively engageable to connect the second transfer shaft 34 with the fourth shaft or interconnecting member 108 and the sun gear 52C. The brake 56 is selectively engageable to connect the second shaft or interconnecting member 104 with the transmission housing 16 in order to restrict relative rotation of the member 104 and therefore the carrier member 50B and ring gear 52A.

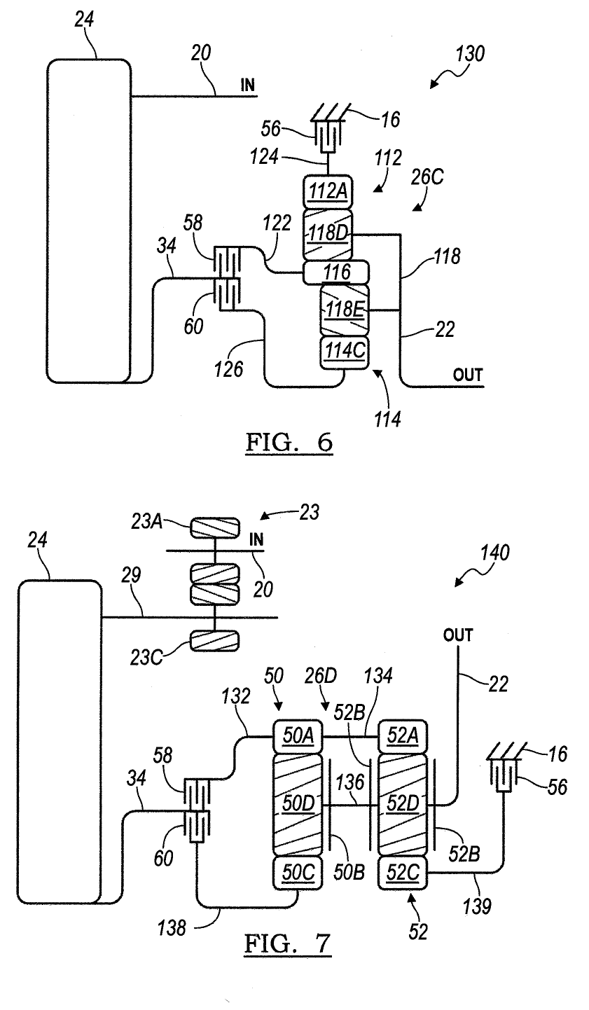

With specific reference to FIG. 6, a transmission 130 having an alternate gearbox 26C arrangement is illustrated. The transmission 130 is similar to transmission 100 shown in FIG. 3 and therefore like components are indicated by like reference numbers. The transmission 130, however, does not have the speed change device 23. Instead, input torque is received directly from the engine. Gearbox 26C includes a first planetary gear set 112 and a second planetary gear set 114. The first planetary gear set 112 and the second planetary gear set 114 are radially stacked. Radially stacked herein means that the planetary gear sets 112 and 114 share a common member 116 and have planet gears that are supported by a shared carrier member 118. Common member 116 is a gear that has gear teeth on an inner surface and gear teeth on an outer surface of the gear. Common member 116 is connected for common rotation to a first interconnecting member 122. Additionally, planetary gear set 112 has a ring gear 112A connected to a second interconnecting member 124. Planetary gear set 114 has a sun gear 114C connected to a third interconnecting member 126. Shared carrier member 118 is connected for common rotation with output shaft 22. The shared carrier member 118 rotatably supports a first set of planet gears 118D and a second set of planet gears 118E. The first set of planet gears 118D intermesh with the gear teeth on the outer surface of common member 116 and with ring gear 112A. The second set of planet gears 118E intermesh with the gear teeth on the inner surface of common member 116 and with sun gear 114C.

Accordingly, first clutch 58 is selectively engageable to connect the second transfer shaft 34 with the first shaft or interconnecting member 122 and the common member 116. The second clutch 60 is selectively engageable to connect the second transfer shaft 34 with the third shaft or interconnecting member 126 and the sun gear 114C. The brake 56 is selectively engageable to connect the second shaft or interconnecting member 124 with the transmission housing 16 in order to restrict relative rotation of the member 124 and therefore ring gear 112A.

With specific reference to FIG. 7, a transmission 140 having an alternate gearbox 26D arrangement is illustrated. The transmission 140 is similar to transmission 100 shown in FIG. 3 and therefore like components are indicated by like reference numbers. Gearbox 26D includes the first planetary gear set 50 and a second planetary gear set 52, as described above. However, the interconnections to clutches 58 and 60 and brake 56 have been reconfigured, as described hereinafter. Ring gear 50A is now connected to a first interconnecting member 132 and to a second interconnecting member 134. Carrier member 50B is now connected to a third interconnecting member 136. Sun gear 50C is now connected to a fourth interconnecting member 138. Moreover, ring gear 52A is now connected to the second interconnecting member 144. Carrier member 52B is now connected to the third interconnecting member 136 and with output member 22. Sun gear 52C is now connected to a fifth interconnecting member 139. Accordingly, first clutch 58 is selectively engageable to connect the second transfer shaft 34 with the first shaft or interconnecting member 132 and the ring gear 50A. The second clutch 60 is selectively engageable to connect the second transfer shaft 34 with the fourth shaft or interconnecting member 138 and the sun gear 50C. The brake 56 is selectively engageable to connect the fifth shaft or interconnecting member 139 with the transmission housing 16 in order to restrict relative rotation of the member 139 and therefore the sun gear 52C.

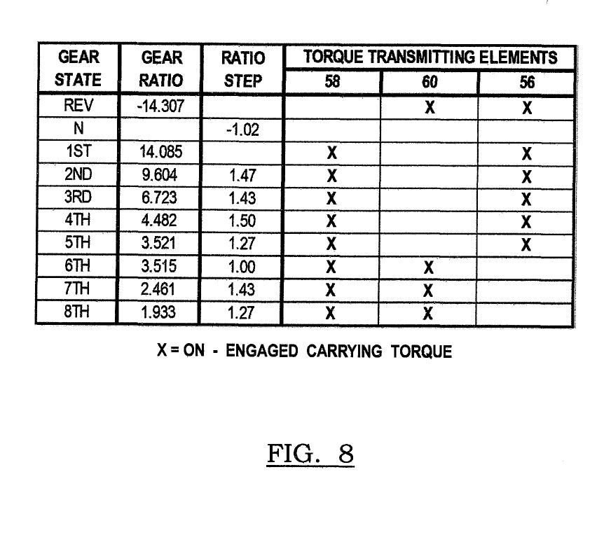

Referring now to FIG. 8, a truth table presenting an example of a state of engagement of various torque transmitting elements to produce multiple forward and at least one reverse speed or gear ratios of the transmissions illustrated in FIGS. 1-7 is shown. The state of engagement of the torque transmitting elements or mechanisms (brake 56 and clutches 58 and 60) is indicted by the presence of an “X” in the appropriate box in the table of FIG. 8. For example, a reverse gear ratio is produced by engaging the brake 56 and the second clutch 60. Of course, an infinite number of ratios may be produced by the transmissions of the present invention through the adjustment of the pulley assembly 24, as described above, and the selection of at least two of the torque transmitting elements or mechanisms, i.e.: brake 56 and clutches 58 and 60, as shown in FIG. 8.

The description of the invention is merely exemplary in nature and variations that do not depart from the gist of the invention are intended to be within the scope of the invention. Such variations are not to be regarded as a departure from the spirit and scope of the invention.

The following is claimed:

1. A transmission for a motor vehicle comprising:
a transmission input member;
a transmission output member;
a continuously variable unit having a first pulley in communication with the input member, a second pulley and an endless member wrapped around the first pulley and the second pulley;
a planetary gear set assembly having first, second, third and fourth members;
a first clutch for selectively connecting the second pulley to the first member of the planetary gear set assembly;
a second clutch for selectively connecting the second pulley to the fourth member of the planetary gear set assembly;
a brake for selectively connecting the third member of the planetary gear set assembly to a stationary member; and
wherein torque is transferred from the input member to the output member through selective engagement of one of the first clutch and the second clutch thereby selectively connecting the second pulley to the planetary gear set assembly.

2. The transmission of claim 1 further comprising a first transfer gear connected for common rotation with the input member and a second transfer gear in mesh with the first transfer gear and connected for common rotation with the first pulley of the continuously variable unit.

3. The transmission of claim 1 wherein planetary gear set assembly further comprises a first planetary gear set and a second planetary gear set, wherein the first planetary gear set has a sun gear connected for common rotation to a sun gear of the second planetary gear set forming the fourth member of the planetary gear set assembly, a carrier member connected for common rotation to the ring gear of the second planetary gear set forming the second member of the planetary gear set assembly and wherein a ring gear of the first planetary gear set forms the first member of the planetary gear set assembly, and a carrier member of the second planetary gear set forms the third member of the planetary gear set assembly.

4. The transmission of claim 3 wherein the first clutch is connected to the ring gear of the first planetary gear set, the second clutch is connected to the sun gear of the first planetary gear set and the brake is connected to carrier member of the second planetary gear set.

5. The transmission of claim 4 wherein the output member is connected for common rotation to the ring gear of the second planetary gear set.

6. The transmission of claim 1 wherein planetary gear set assembly further comprises a first planetary gear set and a second planetary gear set, wherein the first planetary gear set has a carrier member connected for common rotation to a carrier member of the second planetary gear set forming the third member of the planetary gear set assembly and wherein the carrier member of the second planetary gear set has a first and a second set of pinion gears, wherein the first set of pinion gears intermesh with the sun gear of the first planetary gear set and the second set of pinions, and wherein the second set of pinions intermesh with the ring gear of the second planetary gear set and the first set of pinion gears and wherein the ring gear of the second planetary gear set forms the second member of the planetary gear set assembly and wherein the sun gear of the first planetary gear set forms the first member of the planetary gear set assembly and wherein the sun gear of the second planetary gear set forms the fourth member of the planetary gear set assembly.

7. The transmission of claim 6 wherein the first clutch is connected to the sun gear of the first planetary gear set, the second clutch is connected to the sun gear of the second planetary gear set and the brake is connected to carrier member of the first planetary gear set.

8. The transmission of claim 7 wherein the output member is connected for common rotation to the ring gear of the second planetary gear set.

9. The transmission of claim 1 wherein planetary gear set assembly further comprises a first planetary gear set and a second planetary gear set, wherein the first planetary gear set has a carrier member connected for common rotation to a ring gear of the second planetary gear set forming the third member of the planetary gear set assembly and a ring gear of the first planetary gear set is connected for common rotation to a carrier member of the second planetary gear set forming the second member of the planetary gear set assembly and wherein a sun gear of the first planetary gear set forms the first member of the planetary gear set assembly and a sun gear of the second planetary gear set forms the fourth member of the planetary gear set assembly.

10. The transmission of claim 9 wherein the first clutch is connected to the sun gear of the first planetary gear set, the second clutch is connected to the sun gear of the second planetary gear set and the brake is connected to carrier member of the first planetary gear set and ring gear of the second planetary gear set.

11. The transmission of claim 10 wherein the output member is connected for common rotation to the carrier member of the second planetary gear set.

12. The transmission of claim 1 wherein planetary gear set assembly further comprises a first planetary gear set and a second planetary gear set in a stacked arrangement, wherein the first planetary gear set and a second planetary gear set share a common member forming the first member of the planetary gear set assembly, wherein the common member functions as a ring gear in the first planetary gear set and functions as a sun gear in the second planetary gear set, and wherein the first planetary gear set and a second planetary gear set share a common carrier member, forming the second member of the planetary gear set assembly and having a first pinion gear that intermeshes with the sun gear of the first planetary gear set and the common member and a second pinion gear that intermeshes with the ring gear of the second planetary gear set and the common member, wherein the ring gear of the second planetary gear set forms the third member of the planetary gear set assembly and the sun gear of the first planetary gear set forms the fourth member of the planetary gear set assembly.

13. The transmission of claim 12 wherein the first clutch is connected to the common member, the second clutch is connected to the sun gear of the first planetary gear set and the brake is connected to ring gear of the second planetary gear set.

14. The transmission of claim 13 wherein the output member is connected for common rotation with the common carrier member.

15. The transmission of claim 1 wherein planetary gear set assembly further comprises a first planetary gear set and a second planetary gear set, wherein the first planetary gear set has a carrier member connected for common rotation to a carrier member of the second planetary gear set forming the second member of the planetary gear set assembly, and a ring gear of the first planetary gear set is connected for common rotation to a ring gear of the second planetary gear set forming the first member of the planetary gear set assembly, a sun gear of the second planetary gear set forms the third member of the planetary gear set assembly and a sun gear of the first planetary gear set forms the fourth member of the planetary gear set assembly.

16. The transmission of claim 15 wherein the first clutch is connected to the ring gear of the first planetary gear set and ring gear of the second planetary gear set, the second clutch is connected to the sun gear of the first planetary gear set and the brake is connected to sun gear of the second planetary gear set.

17. The transmission of claim 16 wherein the output member is connected for common rotation to the carrier member of the first and second planetary gear sets.

18. A transmission for a motor vehicle comprising:
a transmission input member;
a transmission output member;
a continuously variable unit having a first pulley, a second pulley and an endless member wrapped around the first pulley and the second pulley;
a first transfer gear connected for common rotation with the input member;
a second transfer gear in mesh with the first transfer gear and connected for common rotation with the first pulley of the continuously variable unit;
a planetary gear set assembly having first, second, third and fourth members;
a first clutch for selectively connecting the second pulley to the first member of the planetary gear set assembly;
a second clutch for selectively connecting the second pulley to the fourth member of the planetary gear set assembly;
a brake for selectively connecting the third member of the planetary gear set assembly to a stationary member; and
wherein torque is transferred from the input member to the output member through selective engagement of one of the first clutch and the second clutch thereby selectively connecting the second pulley to the planetary gear set assembly.

19. A transmission for a motor vehicle comprising:
a transmission input member;
a transmission output member;
a continuously variable unit having a first pulley, a second pulley and an endless member wrapped around the first pulley and the second pulley;
a first transfer gear connected for common rotation with the input member;
a second transfer gear in mesh with the first transfer gear and connected for common rotation with the first pulley of the continuously variable unit;
a planetary gear set assembly having a first sun gear, a second sun gear, a first carrier member, a second carrier member, a first ring gear and a second ring gear, wherein the first sun gear is connected for common rotation with the second sun gear and the first carrier member is connected for common rotation with the second ring gear and the output member;
a first clutch for selectively connecting the second pulley to the first sun gear of the planetary gear set assembly;
a second clutch for selectively connecting the second pulley to the second sun gear of the planetary gear set assembly;
a brake for selectively connecting the second carrier member of the planetary gear set assembly to a stationary member; and
wherein torque is transferred from the input member to the output member through selective engagement of one of the first clutch and the second clutch thereby selectively connecting the second pulley to the planetary gear set assembly.
